(19) United States
(12) Patent Application Publication
(10) Pub. No.: US 2009/0072533 A1
(43) Pub. Date: Mar. 19, 2009

(54) Articulated Assembly for Pipelines and a Joint Device

(76) Inventors: Harald Syse, Royneberg (NO); Jostein Aleksandersen, Randaberg (NO)

Correspondence Address: GABLE & GOTWALS, 100 WEST FIFTH STREET, 10TH FLOOR, TULSA, OK, 74103, US

(21) Appl. No.: 11/719,633

(22) PCT Filed: Nov. 16, 2005
(86) PCT No.: PCT/NO05/00431

§ 371 Date: Sep. 20, 2007

(30) Foreign Application Priority Data
Nov. 17, 2004 (NO) 2004 5000

(51) Int. Cl. F16L 27/04

(52) U.S. Cl. 285/263

(57) ABSTRACT

An articulated assembly 1 for insertion into pipelines, the articulated assembly 1 comprising four modules 2 being connected together by respective joint devices 4, and a operating system including transfer means (not shown). The models 2 may typically comprise features such as a bumper nose 6 disposed at each end of the assembly 1, an array of roller wheels 8, packing sections 10 and plugging discs 12. The transfer means of the operating system may comprise power cables such as hydraulic lines and electrical lines as well as control lines, management lines and communication lines, which all form part of the operating system 3 of the articulated assembly. The arrangement of the articulated assembly 1 is such that the joint devices 4 provide protection for the transfer means. The protection is achieved by extending the transfer means through the structure of the joint devices 4. Therefore, the joint devices 4 have a dual function of providing articulation means for the modules and protection means for the operating system of the assembly 1.

The invention relates to an articulated assembly for insertion into pipelines and a joint device for an articulated assembly and is concerned particularly, although not exclusively, with an articulated assembly for plugging pipelines and a joint device for an articulated assembly for plugging pipelines.

### BACKGROUND OF THE INVENTION

When maintaining and possibly developing pipelines, such as pipelines for transporting petroleum products, it is often necessary to insert pigging assemblies or plugging assemblies into the pipeline in order to inspect or repair sections of the pipeline or to be able to shut down longer or shorter sections of the piping system.

Known pigging and plugging assemblies comprise multiple articulated modules connected to each other by joint devices. The joint devices enable the modules to negotiate bends within the pipeline. The articulated modules have an operating system that may comprise many different control lines and operating lines such as electrical cables, hydraulic-tubes and control wires.

We have found that because these lines extend between the modules they are exposed to excessive wear and to potential damage.

The present invention provides advantages over the known assemblies.

### DISCLOSURE OF THE INVENTION

According to a first aspect of the present invention there is provided an articulated assembly for insertion into pipelines, the articulated assembly comprising a plurality of modules being connected by a respective joint device, and transfer means for a operating system, characterised in that at least one joint device is formed with a opening for providing a communication channel between adjacent modules and through which the transfer means extends.

The transfer means of the articulated assemble may comprise power cables such as hydraulic lines and electrical lines, as well as control lines, management lines and communication lines, which all form part of the operating system of the articulated assembly.

The arrangement of the articulated assembly is such that the joint device provides protection for the transfer means of the operating system. The protection is achieved by extending the transfer means through the structure of the joint device. Therefore, the joint device preferably has a dual function of providing articulation means for the modules and protection means for the operating system.

Preferably, the opening of the joint device extends along the length of the joint device.

The joint device preferably comprises a tubular section formed with an opening extending between two ends of the tubular section and through which the transfer means extends.

Preferably, one end of the tubular section forms one part of a first mechanical joint arrangement, a second part of the mechanical joint arrangement being attached to or forming part of a module of the assembly.

Preferably, the opposite end of the tubular section forms one part of a second mechanical joint arrangement, the second part of the second mechanical joint arrangement being attached to or forming part of a module of the assembly.

The opening for providing a communication channel between adjacent modules preferably extends through the second parts of the mechanical joint arrangements.

The mechanical joint arrangements are preferably ball and socket type joints.

The articulated assembly preferably comprises a plurality of joint devices.

According to a second aspect of the present invention there is provided a joint device for an articulated assembly for insertion into pipelines, characterised in that the joint device is formed with a opening for providing a communication channel between adjacent modules of the articulated assembly.

Preferably, the opening extends along the longitudinal length of the joint device.

The joint device preferably comprises a tubular section formed with the opening for providing a communication channel between adjacent respective modules of the articulated assembly.

Preferably, one end of the tubular section forms one half of a part mechanical joint arrangement, the second part of the mechanical joint arrangement being attached to a module of the assembly.

Preferably, the opposite end of the tubular section forms one part of a second mechanical joint arrangement, the second part of the second mechanical joint arrangement being attached to a part of a module of the assembly.

The opening for providing a communication channel between adjacent modules preferably extends through the second parts of the mechanical joint arrangements.

The mechanical joint arrangements are preferably ball and socket type joints.

In an alternative arrangement, the joint device comprises a flexible tubular section, wherein each end of the flexible tubular section is attached to a respective module.

The tubular section preferably comprises a plurality of splitable sections. The splitable sections provide a convenient arrangement for assembling and disassembling the joint device.

The tubular section preferably comprises two sections splitable along the longitudinal axis of the tubular section.

The joint device preferably comprises means for securing the splitable sections together.

The means for securing the splitable sections together is preferably an annular element.

Preferably, in an assembled state of the joint device the securing means is located on the mechanical joint elements of the tubular section.

In an assembled state of the joint device the outermost radius of each mechanical joint element preferably has an outermost radius less than the outermost radius of the portion of the tubular section between the two mechanical joint elements.

The joint device preferably comprises means for locking the securing means.

The means for locking the securing means is preferably an annular element receivable within an annular groove formed in the radially outermost surface of the joint device.

According to a third aspect of the present invention there is provided a joint device for an articulated assembly, characterised in that the joint device is formed with a opening for providing a communication channel between adjacent modules of the articulated assembly and through which transfer means of the articulated module is extendable.

The transfer means of the articulated assemble may comprise power cables such as hydraulic lines and electrical lines, as well as control lines, management lines and communication lines, which all form part of an operating system of the articulated assembly.

The arrangement of the articulated assembly is such that the joint device provides protection for the transfer means of the operating system. The protection is achieved by extending the transfer means through the structure of the joint device. Therefore, the joint device has a dual function of providing articulation means for the modules and protection means for the operating system.

The joint device according to the third aspect of the present invention preferably comprises one or more of the preferable features of the joint device according to the second aspect of the present invention.

While there are particular advantages provided by the present invention according to the first and second aspects of the invention, which are directed towards an articulated assembly that is insertable into a pipeline, the present invention may also be utilised for other types of articulated assemblies that comprises transmission means.

### BRIEF DESCRIPTION OF THE DRAWINGS

A specific embodiment of the invention will now be described by way of example only with reference to the accompanying drawing, in which:—

FIG. 1 is a side elevation of an articulated pigging assembly;

FIG. 2 is a sectional view of a tubular section of a joint device of the articulated pigging assembly of FIG. 1;

FIG. 3 is a side sectional view of the joint device showing the casing in a split configuration; and

FIG. 4 is a side sectional view of the assembled joint device shown in FIG. 3.

### DESCRIPTION OF THE SPECIFIC EMBODIMENTS

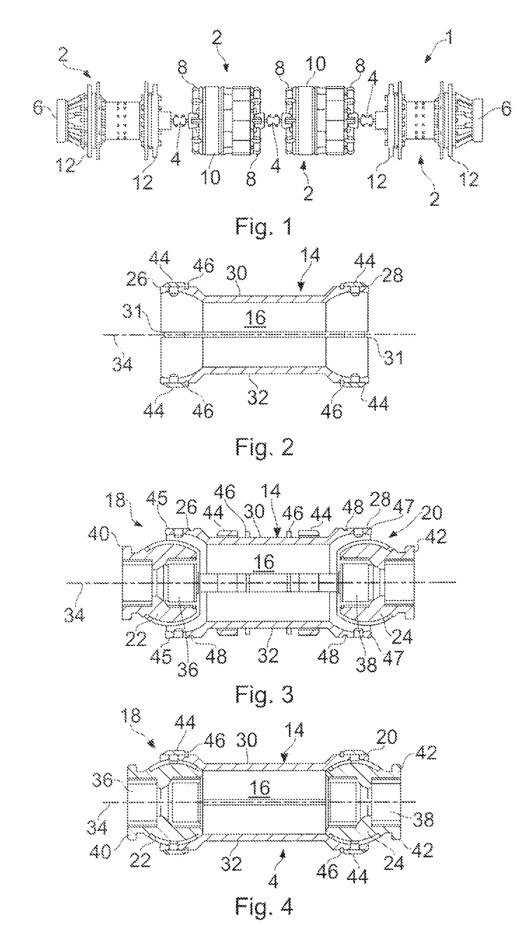

With reference to the FIGS. 1 to 4, there is shown a an articulated assembly 1 for insertion into pipelines, the articulated assembly 1 comprising four modules 2 being connected together by respective joint devices 4, and a operating system including transfer means (not shown).

The models 2 may typically comprise features such as a bumper nose 6 disposed at each end of the assembly 1, an array of roller wheels 8, packing sections 10 and plugging discs 12.

The transfer means of the operating system may comprise power cables such as hydraulic lines and electrical lines as well as control lines, management lines and communication lines, which all form part of the operating system of the articulated assembly.

The arrangement of the articulated assembly 1 is such that the joint devices 4 provide protection for the transfer means. The protection is achieved by extending the transfer means through the structure of the joint devices 4. Therefore, the joint devices 4 have a dual function of providing articulation means for the modules and protection means for the operating system of the assembly 1.

With reference to FIGS. 2 to 4, there is shown a joint device 4. The joint device 4 comprises a tubular section 14 formed with an opening 16 extending longitudinally therethrough. The opening 16 forms a communication channel between adjacent modules 2. The tubular section 14 comprises two longitudinal half sections 30, 32 that are splitable along a central axis 34. In the assembled state (see FIG. 2) there is a longitudinal gap 31 between the two sections 30, 32. The gap 31 extends along the plane of the axis 34. In an alternative arrangement the joint device 4 does not have the gap 31 and the joint device 4 is a sealed enclosed unit.

At each end of the tubular section 14 there is a ball and socket joint arrangement 18, 20. The respective ball and socket joint arrangements 18, 20 each comprise a ball 22, 24 (only shown in FIGS. 3 and 4) and respective sockets 26, 28. The sockets 26, 28 are formed from the end portions of the sections 30, 32. Each ball 22, 24 is formed with a respective hole 36, 38 extending along the axis 34. The holes 36, 38 are in communication with and form part of the opening 16. The two outer ends 40, 42 of the balls 22, 24 are each attached to adjacent modules 2. In an alternative embodiment the balls 22, 24 form part of the respective modules 2. Disposed on the radially outermost surface of each socket 26, 28 there is a securing ring 44 and a locking ring 46. Each securing ring abuts a respective annular shoulder 45, 47 formed on each socket part 26, 28. Each locking ring 46 is received by an annular groove 48 formed in the outermost surface of each socket 26, 28.

The method of assembling the joint device 4 comprises removing the locking rings 46 and the securing rings 44 from the tubular section 14 (as shown in FIG. 3). With the rings 44, 46 removed the two half sections 30, 32 may be separated radially so increasing the radius of the opening 16. The balls 22, 24 may then be placed within the sockets 26, 28 (as shown in FIG. 3). The two half sections 30, 32 may be brought back towards each other so that the inner surfaces of the sockets 26, 28 come into contact with the outer surfaces of the balls 22, 24, so forming respective ball and socket joints. The securing rings 44 are abutted onto the respective shoulders 45, 46 and the locking rings 46 are then placed back into the respective grooves 26, 28 such that the securing rings 44 are held in place.

In the assembled state the joint device 4 comprises a communication channel formed by the opening 16 and holes 36, 38 and through which transfer means extend between adjacent modules 2. The communication channel extends the complete length of the joint device 4 along the axis 34.

The skilled person shall appreciate that the joint device 4 may comprise only one ball joint arrangement or include other types of joint arrangements such as, but not limited to, universal joint arrangements and hinge joint arrangements on condition that the joint arrangements provide protection for the transmission means.

In a further embodiment of the invention the joint device may comprise a flexible tubular section, wherein each end of the flexible tubular section is attached to a respective module. The flexibility of the tubular section allows the assembly to articulate, Due to the flexibility of the tubular section, the joint device may not require any ball joints.

The joint device is made from a material suitably strong enough to withstand the working stresses experienced by pigging and plugging assemblies. The material may be, but not limited to, metal or plastic.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. An articulated assembly for insertion into pipelines, the articulated assembly comprising a plurality of modules connected by a respective joint device, and a transfer means for an operating system, wherein at least one joint device is formed with an opening for providing a communication channel between adjacent modules and through which the transfer means extends.

14. An articulated assembly as claimed in claim 13, wherein the opening extends along the length of the joint device.

15. An articulated assembly as claimed in claim 13, wherein the joint device is comprising a tubular section formed with an opening extending between two ends of the tubular section and through which the transfer means extends.

16. An articulated assembly as claimed in claim 15, wherein one end of the tubular section forms one part of a first mechanical joint arrangement, the second part of the mechanical joint arrangement being attached to or forming part of a module of the assembly.

17. An articulated assembly as claimed in claim 16, wherein the opposite end of the tubular section forms one part of a second mechanical joint arrangement, the second part of the second mechanical joint arrangement being attached to or forming part of a module of the assembly.

18. An articulated assembly as claimed in claim 17, wherein the opening for providing a communication channel between adjacent modules extends through the second parts of the mechanical joint arrangements.

19. An articulated assembly as claimed in claim 16, wherein the mechanical joint arrangements are ball and socket type joints.

20. An articulated assembly as claimed in claim 13, wherein the transfer means of the articulated assemble is comprising power lines and control lines.

21. An articulated assembly as claimed in claim 13, further comprising a plurality of joint devices.

22. A joint device for an articulated assembly of modules for insertion into pipelines, the joint device comprising an opening providing a communication channel between adjacent modules of the articulated assembly.

23. A joint device as claimed in claim 22, wherein the opening extends along the longitudinal length of the joint device.

24. A joint device as claimed in claim 23, further comprising a tubular section formed with the opening providing a communication channel between adjacent respective modules of the articulated assembly.

25. A joint device as claimed in claim 24, wherein one end of the tubular section forms one part of a first mechanical joint arrangement, a second part of the mechanical joint arrangement being attached to one of the modules of the assembly.

26. A joint device as claimed in claim 25, wherein the opposite end of the tubular section forms one part of a second mechanical joint arrangement, the second part of the second mechanical joint arrangement being attached to a part of a module of the assembly.

27. A joint device as claimed in claim 26, wherein the opening for providing a communication channel between adjacent modules extends through the second parts of the mechanical joint arrangements.

28. A joint device as claimed in claim 25, wherein the mechanical joint arrangements are ball and socket type joints.

29. A joint device as claimed in claim 24, wherein the tubular section is comprising a plurality of splitable sections for assembling and disassembling the joint device.

30. A joint device as claimed in claim 29, wherein the tubular section is comprising a plurality of sections splitable along a longitudinal axis of the tubular section.

31. A joint device as claimed in claim 30, further comprising a securing means to secure the splitable sections together.

32. A joint device as claimed in claim 31, wherein the securing means is comprising an annular element.

33. A joint device as claimed in claim 32, wherein with the joint device in an assembled state, the securing means is located on the mechanical joint elements of the tubular section.

34. A joint device as claimed in claim 33, wherein with the joint device in an assembled state, an outermost radius of each mechanical joint element is less than the outermost radius of a portion of the tubular section between the two mechanical joint elements.

35. A joint device as claimed in claim 29, further comprising a locking means for the securing means.

36. A joint device as claimed in claim 35, wherein the locking means is comprising an annular element receivable within an annular groove formed in a radially outermost surface of the joint device.

37. A joint device as claimed in claim 22, wherein each end of the flexible tubular section is attached to a respective module.

38. A joint device for an articulated assembly, comprising a plurality of modules, an opening providing a communication channel between adjacent modules and a transfer means extendable through the communication channel.
